(19) United States
(12) Patent Application Publication
(10) Pub. No.: US 2026/0360173 A1
(43) Pub. Date: Nov. 12, 2026

(54) TRAINING DEVICE, ESTIMATION DEVICE, TRAINING METHOD, ESTIMATION METHOD, AND PROGRAM

(71) Applicant: NTT, Inc., Tokyo (JP)

(72) Inventors: Shota ORIHASHI, Musashino-shi, Tokyo (JP); Ryo MASUMURA, Musashino-shi, Tokyo (JP)

(73) Assignee: NTT, Inc., Tokyo (JP)

(21) Appl. No.: 19/470,151

(22) PCT Filed: Mar. 29, 2023
(86) PCT No.: PCT/JP2023/012913

§ 371 Date: Sep. 29, 2025

(51) Int. Cl. G06V 30/19; G06V 10/77; G06V 10/774; G06V 10/82; G06V 20/70; G06V 30/18

(52) U.S. Cl. CPC G06V 30/19147; G06V 10/7715; G06V 10/774; G06V 10/82; G06V 20/70; G06V 30/18

(57) ABSTRACT

A training apparatus includes processing circuitry configured to extract features from an image of training data by using a first feature extraction model estimate a character region in the image of the training data on a basis of the features by using a first character estimation model estimate an object region in the image of the training data and an object label corresponding to the object region on a basis of the features by using an object estimation model and update parameters of the first feature extraction model, parameters of the first character estimation model, and parameters of the object estimation model on a basis of the estimated character region the estimated object region, the estimated object label, and ground truth data of the image of the training data.

### TECHNICAL FIELD

The present invention relates to a training apparatus, an estimation apparatus, a training method, an estimation method, and a program.

### BACKGROUND ART

A scene image obtained by imaging a scene includes many pieces of character information necessary for understanding the image, such as those of traffic signs and advertisement signboards. The scene character detection is a task of estimating and outputting a character region with such a scene image as an input. In recent years, with the progress of a deep learning technology, a method for implementing scene character detection using an end-to end model has been proposed.

For example, Non Patent Literature 1 discloses a method of scene character detection with a model using a neural network. In the method disclosed in Non Patent Literature 1, with the scene image as an input, a neural network configured by a convolutional neural network or the like estimates and outputs a heat map (hereinafter, a probability map) that represents the degree, the likelihood or the score that each pixel in the scene image is a character region using colors or color intensities corresponding to the magnitude of these values and a heat map (hereinafter, a threshold map) that represents a probability that each pixel in the scene image is a boundary region of the character region.

### CITATION LIST

### Non Patent Literature

Non Patent Literature 1: M. Liao, Z. Zou, Z. Wan, C. Yao, and X. Bai, “Real-Time Scene Text Detection With Differentiable Binarization and Adaptive Scale Fusion,” IEEE Transactions on Pattern Analysis and Machine Intelligence (TPAMI), vol. 45, no. 1, pp. 919-931, 2023.

### SUMMARY OF INVENTION

### Technical Problem

The scene character detection method disclosed in Non Patent Literature 1 detects a region estimated as a character in the input image. However, the method disclosed in Non Patent Literature 1 does not consider what kind of object the detected region belongs to.

For this reason, for example, the scene character detection method disclosed in Non Patent Literature 1 cannot use the knowledge regarding what kind of object the character is likely to belong to, such as that the texture of the animal is not the character region and that the character region is likely to belong to the signboard. Therefore, in the scene character detection method disclosed in Non Patent Literature 1, the character detection cannot be performed with high accuracy.

The present invention has been made in consideration of the description above, and an object of the present invention is to provide a training apparatus, an estimation apparatus, a training method, an estimation method, and a program that can improve the accuracy of the character detection.

### Solution to Problem

In order to solve the above-described problem and achieve the object, according to the present invention, there is provided a training apparatus including: a first extraction unit that extracts features from an image of training data by using a first feature extraction model; a first estimation unit that estimates a character region in the image of the training data on the basis of the features by using a first character estimation model; a second estimation unit that estimates an object region in the image of the training data and an object label corresponding to the object region on the basis of the features by using an object estimation model; and an update unit that updates parameters of the first feature extraction model, parameters of the first character estimation model, and parameters of the object estimation model on the basis of an estimation result obtained from the first estimation unit and an estimation result obtained from the second estimation unit, and ground truth data of the image of the training data.

Furthermore, according to the present invention, there is provided an estimation apparatus including: a second extraction unit that extracts features from a first image by using a second feature extraction model; and a third estimation unit that estimates a character region in the first image on the basis of the features by using a second character estimation model, in which the second feature extraction model and the second character estimation model are models for which parameters are updated on the basis of a character region in an image of training data estimated by the second character estimation model on the basis of features of the image of the training data extracted by the second feature extraction model, an object region in the image of the training data estimated by the object estimation model on the basis of the features of the image of the training data extracted by the second feature extraction model, and an object label corresponding to the object region, and ground truth data of the image of the training data.

### Advantageous Effects of Invention

According to the present invention, the accuracy of the character detection can be improved.

### BRIEF DESCRIPTION OF DRAWINGS

FIG. 1 is a diagram illustrating an outline of processing according to a first embodiment.

FIG. 2 is a diagram illustrating an outline of processing according to the first embodiment.

FIG. 3 is a diagram illustrating an example of a configuration of a training apparatus according to the first embodiment.

FIG. 4 is a flowchart illustrating a processing procedure of training processing according to the first embodiment.

FIG. 5 is a diagram illustrating an example of a configuration of an estimation apparatus according to the first embodiment.

FIG. 6 is a flowchart illustrating a processing procedure of estimation processing according to the first embodiment.

FIG. 7 is a diagram illustrating an example of a configuration of a training apparatus according to a second embodiment.

FIG. 8 is a flowchart illustrating a processing procedure of training processing according to the second embodiment.

FIG. 9 is a diagram illustrating an example of a configuration of a training apparatus according to a third embodiment.

FIG. 10 is a flowchart illustrating a processing procedure of training processing according to the third embodiment.

FIG. 11 is a diagram illustrating an example of a computer in which a program is executed to implement a training apparatus and an estimation apparatus.

### DESCRIPTION OF EMBODIMENTS

Hereinafter, embodiments of a training apparatus, an estimation apparatus, a training method, an estimation method, and a program according to the present application will be described in detail with reference to the drawings. Furthermore, the present invention is not limited to embodiments to be described below.

In the present embodiment, in the scene character detection, in order to utilize knowledge regarding a type of object such as an object that is likely to have characters or an object that is unlikely to have characters, the training of a model that simultaneously executes the character detection and the object detection is executed, and of the character detection and the object detection, the model for the character detection is extracted to use this at the time of inference. Hereinafter, processing of detecting a character region is referred to as character estimation, and processing of detecting an object region and estimating a corresponding label is referred to as object estimation.

Note that, in the following description, an application to scene character detection of detecting (estimating) the character region using a heat map that represents the degree, the likelihood or the score that each pixel in the scene image is a character region using colors or color intensities corresponding to the magnitude of these values, with the scene image as an input, will be mainly described, but the embodiment is not limited to scene character detection using the heat map. That is, the embodiment can be applied to a general technology for estimating the character region from an image including the character region by an arbitrary method that uses a neural network, and the present technology can also be applied to estimating the character region for optical character recognition.

### First Embodiment

First, a first embodiment will be described.

### [Outline of Processing]

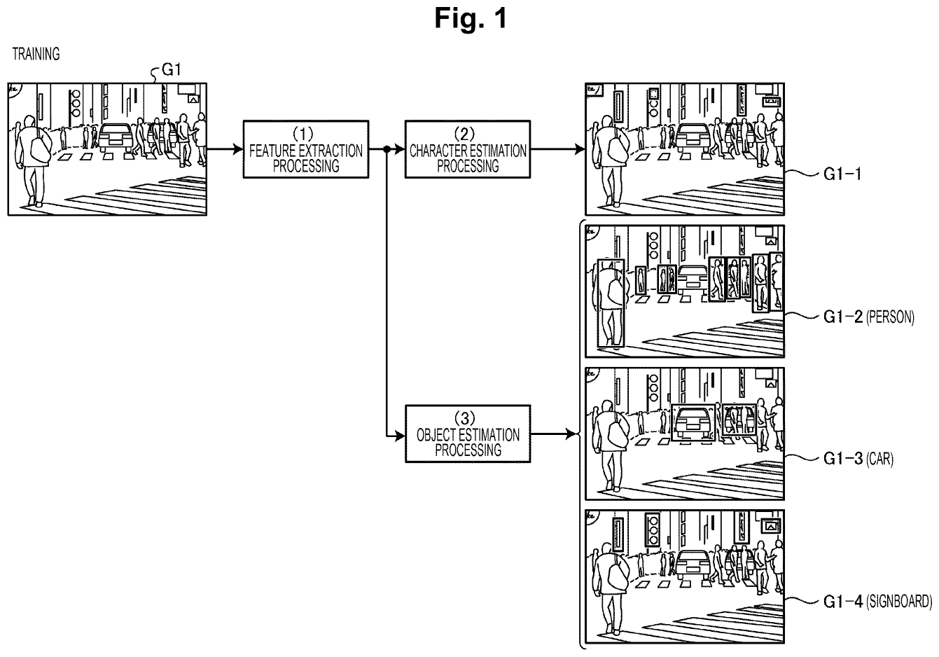

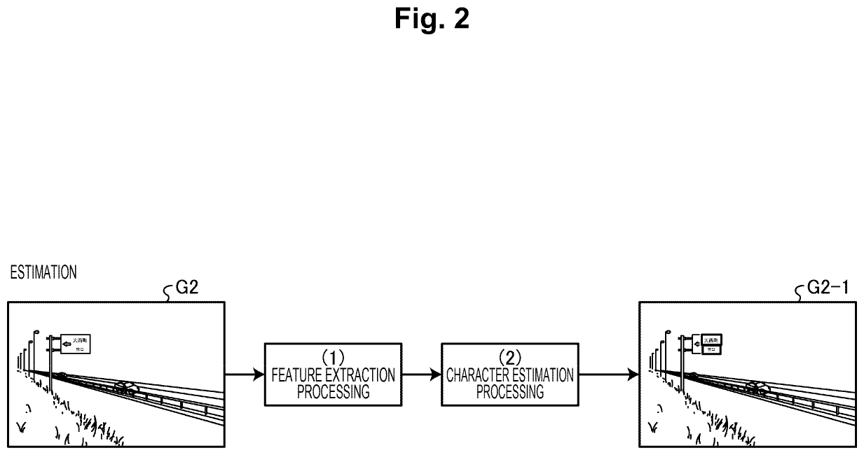

Next, an outline of each processing according to the first embodiment will be described. FIGS. 1 and 2 are diagrams illustrating the outline of processing according to the first embodiment.

In a training phase (FIG. 1), when an image G1 for training is input, a feature extraction model executes feature extraction processing of extracting features (intermediate features) from the image ((1) in FIG. 1). As shown in an image G1-1, the character estimation model executes character estimation processing of estimating the character region on the basis of the intermediate features ((2) in FIG. 1).

Then, as shown in images G1-2 to G1-4, the object estimation model executes the object estimation processing of estimating an object region in the image and an object label (for example, a person, a car, or a signboard) corresponding to the object region on the basis of the intermediate features ((3) in FIG. 1). The character estimation model and the object estimation model are models that share a feature extraction part.

In the training phase, the parameters of the feature extraction model and the character estimation model are updated on the basis of the ground truth character region in the image G1 and the estimated character region in the image G1-1. At the same time, in the training phase, the parameters of the feature extraction model and the object estimation model are updated on the basis of the ground truth object region and the ground truth object label of the image G1, and the estimated object region and the estimated object label of the images G1-2 to G1-4.

In an inference phase, the feature extraction model and the character estimation model are extracted from among the feature extraction model, the character estimation model, and the object estimation model, which are trained in the training phase, and are used at the time of inference.

In the inference phase (FIG. 2), when an image G2 to be estimated is input, the feature extraction model trained in the training phase executes feature extraction processing of extracting intermediate features of the image G2 ((1) in FIG. 2). As shown in an image G2-1, the character estimation model trained in the training phase executes character estimation processing of estimating the character region on the basis of the intermediate features, and outputs the estimated character region ((2) in FIG. 2).

### [Training Apparatus]

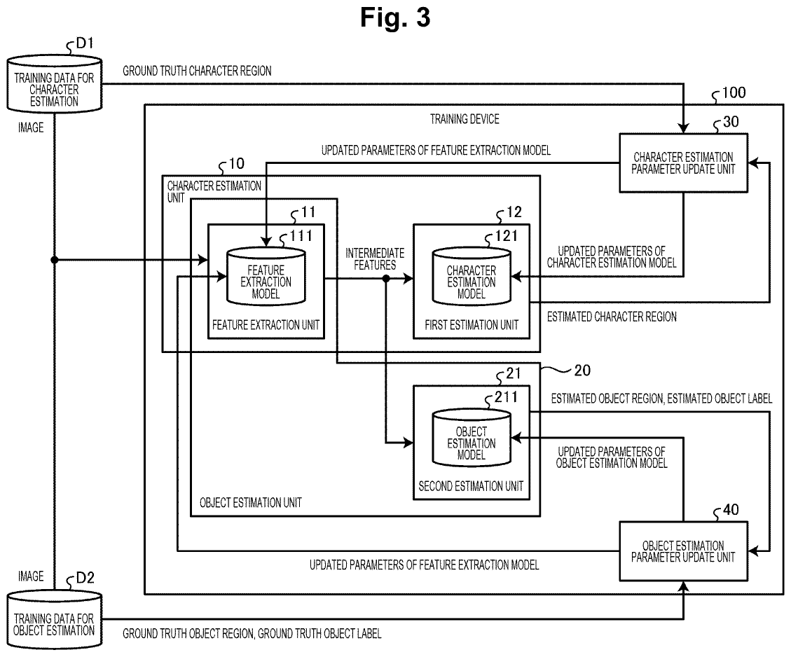

Next, the training apparatus according to the first embodiment will be described. FIG. 3 is a diagram illustrating an example of a configuration of the training apparatus according to the first embodiment.

For example, a training apparatus 100 according to the first embodiment is implemented by a predetermined program being read by a computer or the like including a read only memory (ROM), a random access memory (RAM), and a central processing unit (CPU), the CPU executing the predetermined program. Furthermore, the training apparatus 100 includes a communication interface that transmits and receives various types of information to and from another apparatus connected via a network or the like.

The training apparatus 100 includes a character estimation unit 10, an object estimation unit 20, a character estimation parameter update unit 30 (first update unit), and an object estimation parameter update unit 40 (second update unit). The training apparatus 100 receives inputs of training data D1 for character estimation and training data D2 for object estimation. The training data D1 for character estimation is data including a set of an image and a ground truth character region corresponding to the image. The training data D2 for object estimation is data including a set of an image and a ground truth object region and ground truth object label corresponding to the image.

The character estimation unit 10 receives an image (second image) of the training data D1 for character estimation as an input, and estimates the character region in the image. The character estimation unit 10 outputs the estimated character region as an estimated character region. The ground truth character region of the training data D1 for character estimation and the estimated character region estimated by the character estimation unit 10 are indicated using a heat map format represented by a probability map and a threshold map (see, for example, Non Patent Literature 1). Furthermore, the ground truth character region and the estimated character region may be indicated using a format expressed by a set of coordinates of figures surrounding the region. The character estimation unit 10 includes a feature extraction unit 11 (first extraction unit) and a first estimation unit 12.

The feature extraction unit 11 extracts features from the input image using a feature extraction model 111 (first feature extraction model). For example, the feature extraction unit 11 extracts features from the image (second image) of the training data D1.

The first estimation unit 12 includes a character estimation model 121 (first character estimation model) that estimates the character region in the image when features extracted from the image by the feature extraction unit 11 is input. The first estimation unit 12 estimates the character region in the image of the training data D1 on the basis of the features extracted from the image of the training data D1 using the character estimation model 121.

The feature extraction model 111 and the character estimation model 121 include, for example, a convolutional neural network (see, for example, Non Patent Literature 1), and are defined by being divided into the feature extraction model 111 and the character estimation model 121 with an output of a predetermined layer as a boundary. That is, the feature extraction model 111 is configured by a front-end part of a first neural network divided by a predetermined layer. The character estimation model 121 is configured by a back-end part of the first neural network. Hereinafter, the output of the feature extraction unit 11 is referred to as an intermediate feature.

The object estimation unit 20 receives an input of the image (third image) of the training data D2 for object estimation, and estimates the object region in the image and the object label corresponding to the object region. The object estimation unit 20 outputs the estimated object region and the object label corresponding to the estimated object region as the estimated object region and the estimated object label.

The training data D2 for object estimation is data including a set of an image and a ground truth object region and ground truth object label corresponding to the image. The ground truth object region and the ground truth object label, and the estimated object region and the estimated object label are indicated by using a heat map format expressed by an object center point map of a target object, and an object position offset map and an object size map (a map indicating a size) of the target object (see, for example, Reference Literature 1).

Reference Literature 1: X. Zhou, D. Wang, P. Krahenbuhl, “Objects as Points,” arXiv preprint, arXiv:1904. 07850, 2019.

The object center point map is a heat map representing the probability that each pixel of the image is the center point of the object in the image. The object position offset map is a map representing the offset of the position of the object centered on each pixel of the image. The object size map is a map representing the size of the object. Furthermore, the ground truth object region and the ground truth object label, and the estimated object region and the estimated object label may be indicated by using a format expressed by a set of coordinates of four points of a rectangle surrounding the region and the object label.

The object estimation unit 20 includes a feature extraction unit 11 common to the character estimation unit 10 and a second estimation unit 21.

The feature extraction unit 11 extracts features from the input image of the training data D2 for object estimation by using the feature extraction model 111.

The second estimation unit 21 includes an object estimation model 211 that estimates an object region in the image and an object label corresponding to the object region when the features (intermediate features) extracted from the image by the feature extraction unit 11 is input. The second estimation unit 21 estimates the object region in the image and the object label corresponding to the object region on the basis of the features (intermediate features) extracted from the image by the feature extraction unit 11 by using the object estimation model 211. The object estimation model 211 includes a second neural network such as a convolutional neural network.

The character estimation parameter update unit 30 updates the parameters of the feature extraction model 111 and the parameters of the character estimation model 121 by performing supervised learning. For example, the character estimation parameter update unit 30 receives, as inputs, the estimated character region by the first estimation unit 12 and the ground truth character region in the image of the training data D1. The character estimation parameter update unit 30 updates the parameters of the feature extraction model 111 and the parameters of the character estimation model 121 on the basis of the ground truth character region and the estimated character region. The character estimation parameter update unit 30 updates the parameters of the feature extraction model 111 and the parameters of the character estimation model 121 by performing supervised learning that uses the ground truth character region as ground truth data. This processing is general as the supervised learning.

The character estimation parameter update unit 30 derives the updated parameters of the neural network (the feature extraction model 111 and the character estimation model 121) of the character estimation unit 10 such that the value of a predefined error function decreases, and outputs the parameters as the updated parameters of the feature extraction model 111 and the updated parameters of the character estimation model 121.

When the updated parameters of the feature extraction model 111 and the updated parameters of the character estimation model 121 are input, the character estimation unit 10 updates the parameters of the feature extraction model 111 and the parameters of the character estimation model 121 to the updated parameters, respectively.

The error function used by the character estimation parameter update unit 30 is only required to be any function whose value decreases as the difference between the estimated character region and the ground truth character region decreases. For example, in a case where the heat map format is used as in Non Patent Literature 1, the difference is only required to be defined as a difference between each heat map corresponding to the estimated character region and each heat map corresponding to the ground truth character region.

The object estimation parameter update unit 40 updates the parameters of the feature extraction model 111 and the parameters of the object estimation model 211 by performing supervised learning. For example, the object estimation parameter update unit 40 receives, as inputs, the estimated object region and the estimated object label obtained from the second estimation unit 21 and the ground truth object region and ground truth object label in the image of the training data D2. The object estimation parameter update unit 40 updates the parameters of the feature extraction model 111 and the parameters of the object estimation model 211 on the basis of the estimated object region and the estimated object label, and the ground truth object region and the ground truth object label. The object estimation parameter update unit 40 updates the parameters of the feature extraction model 111 and the parameters of the object estimation model 211 by performing supervised learning that uses the ground truth object region and ground truth object label as ground truth data. This processing is general as the supervised learning.

The object estimation parameter update unit 40 derives the updated parameters of the neural network (the feature extraction model 111 and the object estimation model 211) of the object estimation unit 20 such that the value of a predefined error function decreases, and outputs the parameters as the updated parameters of the feature extraction model 111 and the updated parameters of the object estimation model 211.

When the updated parameters of the feature extraction model 111 and the updated parameters of the object estimation model 211 are input, the object estimation unit 20 updates the parameters of the feature extraction model 111 and the parameters of the object estimation model 211 to the updated parameters, respectively.

The error function used by the object estimation parameter update unit 40 is only required to be any function whose value decreases as the difference between the estimated object region and the estimated object label, and the ground truth object region and the ground truth object label decreases. For example, in a case where the heat map format is used as in Reference Literature 1, the difference is only required to be defined as a difference between each heat map representing the estimated object region and the estimated object label, and each heat map representing the ground truth object region and the ground truth object label.

### [Training Processing]

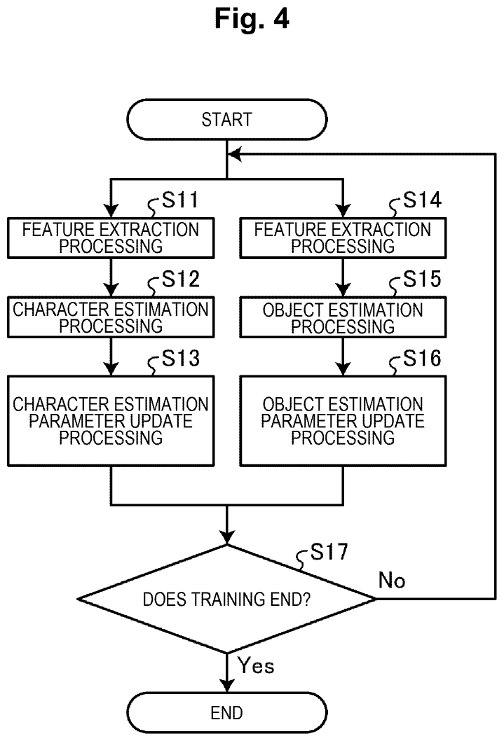

FIG. 4 is a flowchart illustrating a processing procedure of the training processing according to the first embodiment.

As illustrated in FIG. 4, in the training apparatus 100, when the image of the training data D1 is input, the feature extraction unit 11 executes feature extraction processing of extracting intermediate features of the image of the training data D1 (step S11). The first estimation unit 12 executes character estimation processing of estimating the character region in the image of the training data D1 on the basis of the intermediate features extracted from the image of the training data D1 in Step S11 (Step S12).

The character estimation parameter update unit 30 performs character estimation parameter update processing of updating the parameters of the feature extraction model 111 and the parameters of the character estimation model 121 on the basis of the ground truth character region in the image of the training data D1 and the estimated character region estimated in step S12 (step S13).

Then, when the image of the training data D2 is input, the feature extraction processing of extracting the intermediate features of the image is executed (step S14). The second estimation unit 21 executes the object estimation processing of estimating the object region in the image of the training data D2 and the object label corresponding to the object region on the basis of the intermediate features extracted from the image of the training data D2 (step S15).

The object estimation parameter update unit 40 performs object estimation parameter update processing of updating the parameters of the feature extraction model 111 and the parameters of the object estimation model 211 on the basis of the ground truth object region and the ground truth object label in the image of the training data D2, and the estimated object region and the estimated object label estimated in step S15 (step S16).

The training apparatus 100 determines whether or not a condition for ending the training is satisfied (step S17). For example, the condition for ending the training may be satisfied when the training reaches a fixed number of epochs, or may be satisfied when the value of the error function for development data does not decrease a certain number of times by using part of the training data as the development data.

In a case where the condition for ending the training is not satisfied (step S17: No), the training apparatus 100 repeats the processing in steps S11 to S16 until the condition for the training processing is satisfied. In a case where the condition for ending the training is satisfied (step S17: Yes), the training apparatus 100 ends the training processing.

Note that the processing procedure in FIG. 4 is an example of the training processing according to the first embodiment. For example, the processing in steps S11 to S13 and the processing in steps S14 to S16 may be performed in parallel or in random order.

### [Estimation Apparatus]

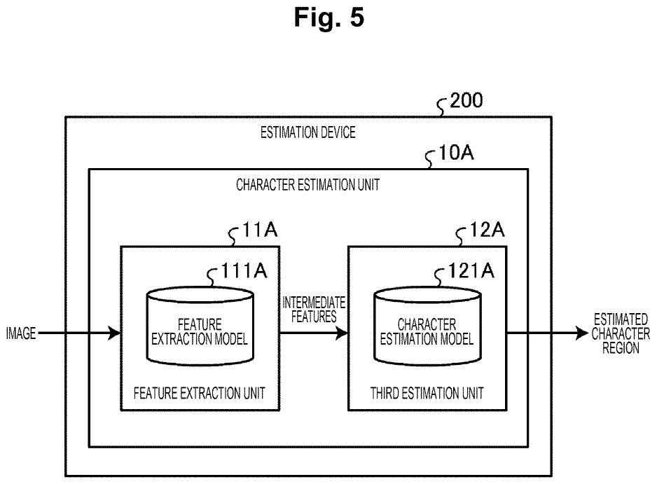

Next, the estimation apparatus according to the first embodiment will be described. FIG. 5 is a diagram illustrating an example of a configuration of the estimation apparatus according to the first embodiment.

For example, an estimation apparatus 200 according to the first embodiment is implemented by a predetermined program being read by a computer or the like including a ROM, a RAM, and a CPU, the CPU executing the predetermined program. Furthermore, the estimation apparatus 200 includes a communication interface that transmits and receives various types of information to and from another apparatus connected via a network or the like.

As illustrated in FIG. 5, the estimation apparatus 200 includes a character estimation unit 10A. The character estimation unit 10A receives the image (first image) as an input, estimates the character region in the image, and outputs the character region as the estimated character region.

The character estimation unit 10A includes a feature extraction unit 11A (second extraction unit) and a third estimation unit 12A. The feature extraction unit 11A includes a feature extraction model 111A (second feature extraction model) and extracts features from the input image (first image). The third estimation unit 12A includes a character estimation model 121A (second character estimation model), and estimates a character region in the input image on the basis of the features extracted by the feature extraction unit 11A.

Similarly to the training apparatus 100, the feature extraction model 111A is configured by a front-end part of the neural network (third neural network) divided by a predetermined layer, and the character estimation model 121A is configured by a back-end part of the neural network (third neural network). Hereinafter, the features output by the feature extraction model 111A are referred to as intermediate features.

In the feature extraction model 111A and the character estimation model 121A, model parameters of the feature extraction model 111 and the character estimation model 121, which are respectively updated, are set in the training apparatus 100. Therefore, it can be said that the feature extraction model 111A and the character estimation model 121A are character estimation models that acquire information regarding what kind of object the character is likely to belong to.

### [Estimation Processing]

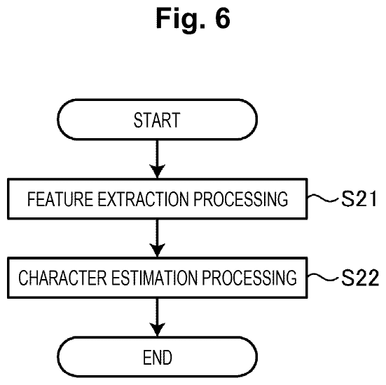

FIG. 6 is a flowchart illustrating a processing procedure of estimation processing according to the first embodiment. As illustrated in FIG. 6, in the estimation apparatus 200, when the image to be estimated is input, the feature extraction unit 11A executes feature extraction processing of extracting intermediate features of the image (step S21).

The third estimation unit 12A executes character estimation processing of estimating the character region in the image on the basis of the intermediate features extracted from the image in Step S21 (Step S22). Then, the estimation apparatus 200 outputs the estimated character region.

### [Effects of First Embodiment]

Here, in the character detection technology of the related art, the training is performed without explicitly giving knowledge regarding what kind of object the character region is likely to belong to and what kind of object the character region is unlikely to belong to.

On the other hand, in the first embodiment, a model capable of character detection and object detection is simultaneously trained as a model that shares an internal feature extraction part. Thus, in the first embodiment, for example, the accuracy of character detection is improved by causing the character detection model to acquire information regarding what kind of object the character is likely to belong to, such as that the texture of the animal is not the character region and that the character region is likely to belong to the signboard. In particular, the effect is easily exhibited in a case where the estimated character region, the object region, and the ground truth object label are all indicated in a heat map format in which spatial characteristics are maintained.

### Second Embodiment

Next, a second embodiment will be described. In the second embodiment, the training is executed using the training data in which an image, a ground truth character region, a ground truth object region, and a ground truth object label form one set.

### [Training Apparatus]

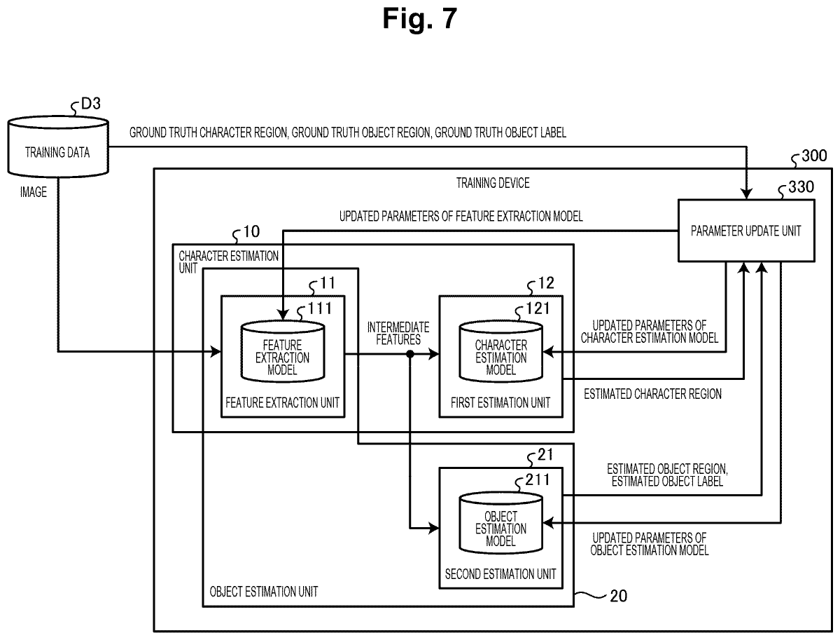

FIG. 7 is a diagram illustrating an example of a configuration of a training apparatus according to a second embodiment. For example, a training apparatus 300 according to the second embodiment is implemented by a predetermined program being read by a computer or the like including a ROM, a RAM, and a CPU, the CPU executing the predetermined program. Furthermore, the training apparatus 300 includes a communication interface that transmits and receives various types of information to and from another apparatus connected via a network or the like.

The training apparatus 300 executes training of the feature extraction model 111, the character estimation model 121, and the object estimation model 211 by using training data D3 including a set of an image, and a ground truth character region, ground truth object region, and ground truth object label corresponding to the image.

The character estimation unit 10 and the object estimation unit 20 receive an image of the training data D3 as an input. The character estimation unit 10 estimates a character region in the image of the training data D3, and outputs the character region as an estimated character region. The object estimation unit 20 estimates an object region in the image of the training data D3 and an object label corresponding to the object region, and outputs the object region and the object label corresponding to the object region as the estimated object region and the estimated object label.

The training apparatus 300 includes a parameter update unit 330 (update unit) instead of the character estimation parameter update unit 30 and the object estimation parameter update unit 40 of the training apparatus 100 illustrated in FIG. 3.

The parameter update unit 330 receives, as inputs, the estimated character region estimated by the first estimation unit 12, the estimated object region and estimated object label estimated by the second estimation unit 21, and the ground truth character region, ground truth object region, and ground truth object label in the image of the training data D3.

The parameter update unit 330 updates the parameters of the feature extraction model 111 and the parameters of the character estimation model 121 and object estimation model 211 by performing supervised learning. The parameter update unit 330 updates the parameters of the feature extraction model 111, the character estimation model 121, and the object estimation model 211 on the basis of the estimated character region, the estimated object region and the estimated object label, and the ground truth character region, the ground truth object region and the ground truth object label. The parameter update unit 330 updates the parameters of the feature extraction model 111, the character estimation model 121, and the object estimation model 211 by performing supervised learning that uses the ground truth character region, the ground truth object region, and the ground truth object label as ground truth data. This processing is general as the supervised learning.

The parameter update unit 330 derives the updated parameters of the neural networks (the feature extraction model 111, the character estimation model 121, and the object estimation model 211) of the character estimation unit and the object estimation unit such that the value of a predefined error function decreases, and outputs the parameters as the updated parameters of the feature extraction model 111, the updated parameters of the character estimation model 121, and the updated parameters of the object estimation model 211. The error function to be used is only required to be any function whose value decreases as the difference between the estimated character region, the estimated object region and the estimated object label, and the ground truth character region, the ground truth object region and the ground truth object label decreases.

When the updated parameters of the feature extraction model 111, the updated parameters of the character estimation model 121, and the updated parameters of the object estimation model 211 are input, the character estimation unit 10 and the object estimation unit 20 update the networks with the updated parameters, respectively.

The estimation apparatus according to the second embodiment has the same configuration as that in FIG. 5, and the model parameters of the feature extraction model 111 and the character estimation model 121, for which the parameters are updated by the training apparatus 300, are set for the feature extraction model 111A and the character estimation model 121A.

### [Training Processing]

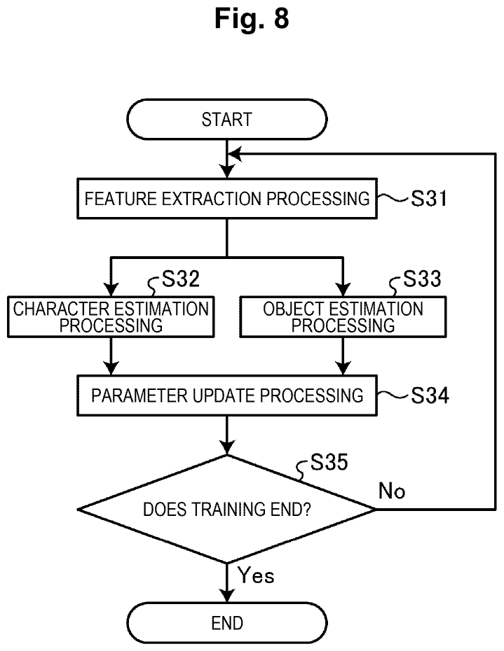

FIG. 8 is a flowchart illustrating a processing procedure of the training processing according to the second embodiment.

As illustrated in FIG. 8, in the training apparatus 300, when the image of the training data D3 is input, the feature extraction unit 11 executes feature extraction processing of extracting intermediate features of the image of the training data D3 (step S31).

The first estimation unit 12 executes character estimation processing of estimating the character region in the image of the training data D3 on the basis of the intermediate features extracted from the image of the training data D3 in Step S31 (Step S32). The second estimation unit 21 executes object estimation processing of estimating the object region in the image of the training data D3 and the object label corresponding to the object region on the basis of the intermediate features extracted from the image of the training data D3 in step S31 (step S33).

The parameter update unit 330 receives, as inputs, the ground truth character region, the ground truth object region, and the ground truth object label in the image of the training data D3. The parameter update unit 330 further receives, as inputs, the estimated character region in the image of the training data D3 estimated in step S32, and the estimated object region and the estimated object label corresponding to the estimated object region in the image of the training data D3 estimated in step S33. The parameter update unit 330 performs parameter update processing of updating the parameters of the feature extraction model 111, the character estimation model 121, and the object estimation model 211 on the basis of the estimated character region, the estimated object region, and the estimated object label, which are estimated in steps S32 and S33, and the ground truth character region, the ground truth object region, and the ground truth object label (step S34). Step S35 is the same processing as step S17 in FIG. 4.

Note that the processing procedure in FIG. 8 is an example of the training processing according to the second embodiment. For example, the processing of step S32 and the processing of step S33 may be performed in random order.

### [Effects of Second Embodiment]

In the second embodiment, a case where the training is executed using the training data in which an image, a ground truth character region, a ground truth object region, and a ground truth object label form one set has the same effects as in the first embodiment.

Note that the first embodiment and the second embodiment may be applied simultaneously. That is, part of the training data may have annotations of the ground truth character regions, part of the training data may have annotations of the ground truth object regions and the ground truth object labels, and the rest of the training data may have all the remaining annotations. In this case, the training may be performed by appropriately switching the character estimation parameter update processing, the object estimation parameter update processing, and the parameter update processing.

### Third Embodiment

Next, a third embodiment will be described. In the third embodiment, the ground truth object region and the ground truth object label are generated in a pseudo manner by estimating the object region and the object label in the image of the training data D1 for character estimation.

### [Training Apparatus]

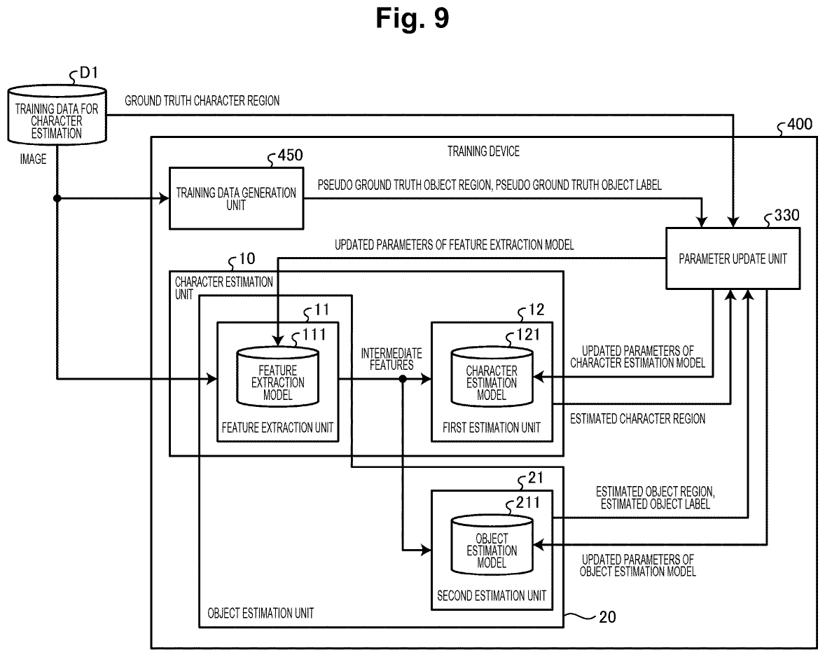

FIG. 9 is a diagram illustrating an example of a configuration of a training apparatus according to a third embodiment. For example, a training apparatus 400 according to the third embodiment is implemented by a predetermined program being read by a computer or the like including a ROM, a RAM, and a CPU, the CPU executing the predetermined program. Furthermore, the training apparatus 400 includes a communication interface that transmits and receives various types of information to and from another apparatus connected via a network or the like.

The training apparatus 400 uses, as training data, the training data D1 for character estimation, which includes a set of an image and a ground truth character region corresponding to the image.

Then, the training apparatus 400 further includes a training data generation unit 450 (fourth estimation unit) as compared with the training apparatus 300.

The training data generation unit 450 includes an object detector trained in advance, and estimates the object region and the object label in the input image. The training data generation unit 450 receives the image of the training data D1 for character estimation as an input, and estimates the object region and the object label in the image of the training data D1. The training data generation unit 450 outputs the estimated object region and the estimated object label to the parameter update unit 330 as a pseudo ground truth object region and a pseudo ground truth object label. The pseudo ground truth object region and the pseudo ground truth object label are used as training data. Any object detector can be used as the trained object detector.

The parameter update unit 330 receives, as inputs, the estimated character region estimated by the first estimation unit 12, the estimated object region and estimated object label estimated by the second estimation unit 21, the ground truth character region in the image of the training data D1, and the pseudo ground truth object region and pseudo ground truth object label generated by the training data generation unit 450. The parameter update unit 330 uses, as training data, the ground truth character region in the image of the training data D1, and the pseudo ground truth object region and pseudo ground truth object label generated by the training data generation unit 450, and performs processing similar to that of the second embodiment.

The parameter update unit 330 updates the parameters of the feature extraction model 111, the character estimation model 121, and the object estimation model 211 on the basis of the estimated character region, the estimated object region and the estimated object label, and the ground truth character region, the pseudo ground truth object region and the pseudo ground truth object label.

The estimation apparatus according to the third embodiment has the same configuration as that in FIG. 5, and the model parameters of the feature extraction model 111 and the character estimation model 121, for which the parameters are updated by the training apparatus 400, are set for the feature extraction model 111A and the character estimation model 121A.

### [Training Processing]

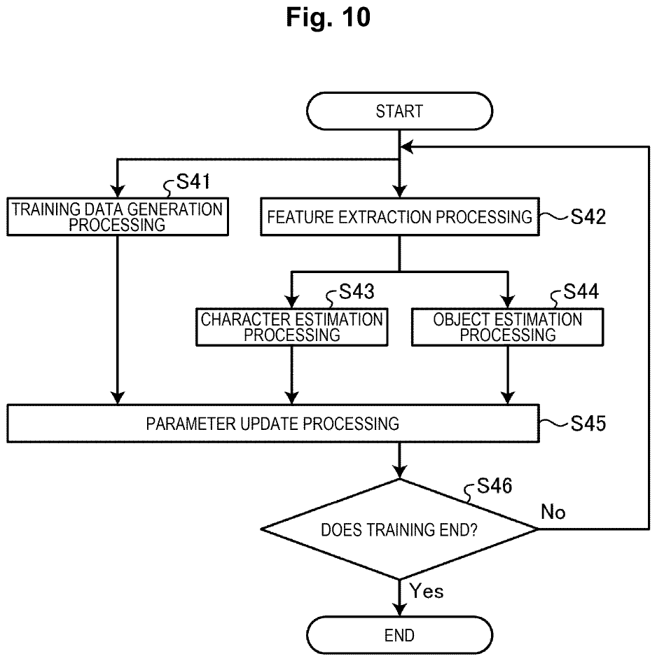

FIG. 10 is a flowchart illustrating a processing procedure of the training processing according to the third embodiment.

As illustrated in FIG. 10, in the training apparatus 400, when the image of the training data D1 is input, the training data generation unit 450 estimates the pseudo ground truth object region and the pseudo ground truth object label in the image of the training data D1, and performs training data generation processing of generating the training data (step S41).

Steps S42 to S44 illustrated in FIG. 10 are the same processing as steps S31 to S33 illustrated in FIG. 8.

The parameter update unit 330 uses, as training data, the ground truth character region in the image of the training data D1, and the pseudo ground truth object region and pseudo ground truth object label generated in step S41, and performs parameter update processing of updating the parameters of the feature extraction model 111, the character estimation model 121, and the object estimation model 211 (step S45). Step S46 is the same processing as step S17 in FIG. 4.

### [Effects of Third Embodiment]

As described above, in the third embodiment, by using the trained object detector, training can be performed by generating a label of the object detection in a pseudo manner on the basis of the training data D1 for character estimation. Therefore, in the third embodiment, it is possible to easily give the object estimation information to each model without newly collecting training data in addition to the training data D1 for character estimation.

Note that the first embodiment, the second embodiment, and the third embodiment may be applied simultaneously. That is, part of the training data may have annotations of the ground truth character regions, and the pseudo ground truth object region and the pseudo ground truth object label may be given as the annotation in a pseudo manner. Part of the training data may have annotations of the ground truth object regions and the ground truth object labels, and the rest of the training data may have all the remaining annotations. In this case, the training is only required to be performed by appropriately switching the object estimation parameter update processing (step S16 in FIG. 4), the parameter update processing in the second embodiment (step S34 in FIG. 8), and the parameter update processing in the third embodiment (step S45 in FIG. 10).

Furthermore, in a case where the pseudo ground truth object region and the pseudo ground truth object label are used, for example, the training may be performed to minimize the influence in a case where the pseudo ground truth object region and the pseudo ground truth object label are incorrect by reducing the weight of the error function related to object detection or adjusting the weight of the error function corresponding to the pseudo ground truth object region and the pseudo ground truth object label according to the degree of reliability output by the trained object detector.

### [Regarding System Configuration of Embodiment]

The components of the training apparatuses 100, 300, and 400, and the estimation apparatus 200, which are described above, are functionally conceptual, and do not have to be physically configured as illustrated in the drawings. That is, specific forms of distribution and integration of the functions of the training apparatuses 100, 300, and 400, and the estimation apparatus 200 are not limited to the illustrated forms, and all or a part thereof can be functionally or physically distributed or integrated in any unit according to various loads, usage conditions, and the like.

Furthermore, all or any part of the processing performed in the training apparatuses 100, 300, and 400, and the estimation apparatus 200 may be implemented by a CPU and a program analyzed and executed by the CPU. Furthermore, each processing performed in the training apparatus 100 may be implemented as hardware by wired logic.

Furthermore, in the processing described in the embodiments, all or part of the processing described as being automatically performed can be manually performed. Alternatively, all or part of the processing described as being manually performed can be automatically performed by a known method. In addition, the above-mentioned and illustrated processing procedures, control procedures, specific names, and information including various types of data and parameters can be appropriately changed unless otherwise specified.

### [Program]

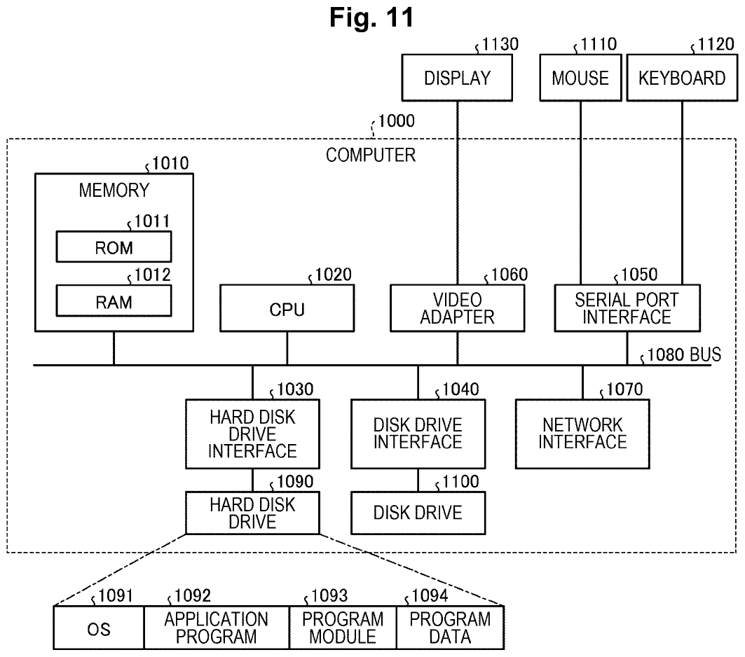

FIG. 11 is a diagram illustrating an example of a computer in which a program is executed to implement the training apparatuses 100, 300, and 400, and the estimation apparatus 200. A computer 1000 includes, for example, a memory 1010 and a CPU 1020. Furthermore, the computer 1000 includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a detachable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program that defines each processing operation of the training apparatus 100 is implemented as the program module 1093 in which codes executable by the computer 1000 are described. The program module 1093 is stored in, for example, the hard disk drive 1090. For example, the program module 1093 for executing processing similar to that of the functional configuration in the training apparatus 100 is stored in the hard disk drive 1090. Note that the hard disk drive 1090 may be replaced with a solid state drive (SSD).

Furthermore, setting data used in the processing of the above-described embodiments is stored, for example, in the memory 1010 or the hard disk drive 1090 as the program data 1094. Then, the CPU 1020 reads the program module 1093 and the program data 1094 stored in the memory 1010 and the hard disk drive 1090 to the RAM 1012 as necessary and executes them.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

While the embodiments to which the invention made by the present inventors is applied have been described above, the present invention is not limited by the description and the drawings constituting part of the disclosure of the embodiments according to the present invention. In other words, other embodiments, examples, operation techniques, and the like made by those skilled in the art and the like on the basis of the present embodiments are all included in the scope of the present invention.

### REFERENCE SIGNS LIST

10, 10A Character estimation unit
11, 11A Feature extraction unit
12 First estimation unit
12A Third estimation unit
20 Object estimation unit
21 Second estimation unit
30 Character estimation parameter update unit
40 Object estimation parameter update unit
100, 300, 400 Training apparatus
111, 111A Feature extraction model
121, 121A Character estimation model
200 Estimation apparatus
211 Object estimation model
330 Parameter update unit
450 Training data generation unit

1. A training apparatus comprising:
processing circuitry configured to:
extract features from an image of training data by using a first feature extraction model;
estimate a character region in the image of the training data on a basis of the features by using a first character estimation model;
estimate an object region in the image of the training data and an object label corresponding to the object region on a basis of the features by using an object estimation model; and
update parameters of the first feature extraction model, parameters of the first character estimation model, and parameters of the object estimation model on a basis of the estimated character region the estimated object region, the estimated object label, and ground truth data of the image of the training data.

2. An estimation apparatus comprising:
processing circuitry configured to:
extract features from a first image by using a second feature extraction model; and
estimate a character region in the first image on a basis of the features by using a second character estimation model, wherein
the second feature extraction model and the second character estimation model are models for which parameters are updated on a basis of a character region in an image of training data estimated by the second character estimation model on a basis of features of the image of the training data extracted by the second feature extraction model, an object region in the image of the training data estimated by the object estimation model on a basis of the features of the image of the training data extracted by the second feature extraction model, and an object label corresponding to the object region, and ground truth data of the image of the training data.

3. The training apparatus according to claim 1, wherein the processing circuitry is further configured to
extract features of a second image of training data associated with a ground truth character region, and extracts features of a third image of training data associated with a ground truth object region and a ground truth object label,
estimate a character region in the second image,
estimate an object region in the third image and an object label corresponding to the object region,
update the parameters of the first feature extraction model and the parameters of the first character estimation model on a basis of the character region and the ground truth character region in the second image, and
update the parameters of the first feature extraction model and the parameters of the object estimation model on a basis of the object region and the object label corresponding to the object region and the ground truth object region and ground truth object label in the third image.

4. The training apparatus according to claim 1, wherein the processing circuitry is further configured to receive, as an input, an image of training data associated with a ground truth character region, and estimate an object region and an object label in the image of the training data by using an object detector trained in advance
update the parameters of the first feature extraction model, the parameters of the first character estimation model, and the parameters of the object estimation model by using a ground truth character region associated with the training data and the object region and object label as ground truth data of the training data.

5. A training method, comprising:
extracting features from an image of training data by using a first feature extraction model;
estimating a character region in the image of the training data on a basis of the features by using a first character estimation model;
estimating an object region in the image of the training data and an object label corresponding to the object region on a basis of the features by using an object estimation model; and
parameters of the first feature extraction model, parameters of the first character estimation model, and parameters of the object estimation model on a basis of the estimated character region and the estimated object region, the estimated object label and ground truth data of the image of the training data by using a processor.

6. An estimation method, comprising:
extracting features from a first image by using a second feature extraction model; and
estimating a character region in the first image on a basis of the features by using a second character estimation model by using a processor, wherein
the second feature extraction model and the second character estimation model are models for which parameters are updated on a basis of a character region in an image of training data estimated by the second character estimation model on a basis of features of the image of the training data extracted by the second feature extraction model, an object region in the image of the training data estimated by the object estimation model on a basis of the features of the image of the training data extracted by the second feature extraction model, and an object label corresponding to the object region, and ground truth data of the image of the training data.

7. A program for causing a computer to function as the training apparatus according to claim 1.
